(19) United States
(12) Patent Application Publication
(10) Pub. No.: US 2014/0318345 A1
(43) Pub. Date: Oct. 30, 2014

(54) SYSTEMS AND METHODS FOR PROVIDING NAVIGATIONAL MARKS ON A STRINGED INSTRUMENT FINGERBOARD

(71) Applicants: Douglas D. Fraser, Lake View Terrace, CA (US); Holly J. S. Fraser, Lake View Terrace, CA (US)

(72) Inventors: Douglas D. Fraser, Lake View Terrace, CA (US); Holly J. S. Fraser, Lake View Terrace, CA (US)

(21) Appl. No.: 13/871,280

(22) Filed: Apr. 26, 2013

(51) Int. Cl. G10D 3/06

(52) U.S. Cl. CPC G10D 3/06
USPC 84/314 R

(57) ABSTRACT

Systems and methods for providing navigational marks on a fingerboard of a stringed instrument are provided. An example system may allow enhanced navigating of a player on the fingerboard of the stringed instrument. The system may comprise the fingerboard of the stringed instrument. Strings may be attached to the instrument over the fingerboard. A note may be produced by stimulating a part of a string associated with the note. The part of the string may be called a note location on the fingerboard. The navigational marks may be disposed on the fingerboard in association with the strings to mark note locations on the fingerboard and thus facilitate finding the note location. The navigational marks may include a plurality of types, with each type associated with a note of an octave and having a specific shape.

### TECHNICAL FIELD

This disclosure generally relates to stringed instruments and, more specifically, to systems and methods for providing navigational marks on a stringed instrument fingerboard.

### BACKGROUND

Conventional methods of musical notation, usually based on seven notes (C, D, E, F, G, A, and B) are used by musicians of different genres. However, musicians playing stringed instruments, such as a classic, electric, or bass guitar, or a ukulele, may find it difficult to learn note locations and read music. The reason for that is repetition of notes along the neck of a stringed instrument. A musician can play the same note using different strings.

A fingerboard of a conventional guitar has several strips, called frets, dividing the fingerboard. Pressing a string against a fret determines the vibrating length of the string and, therefore, the note it will generate. Classical guitars have 19 frets while electric guitars have between 21 to 24 frets, although guitars have been made with as many as 27 frets. To differentiate between frets, the existing guitar fretboard design only offers 8-9 navigational marks. Called inlays, they usually appear on the odd numbered frets, but also on the 12th fret. Thus, the conventional guitar offers between 126-138 different note locations and just 8-9 navigational marks. This complicates navigating the guitar neck, efficient improvisation, and ability to read music.

### BRIEF DESCRIPTION OF THE DISCLOSURE

According to one or more example embodiments of the disclosure, there are provided systems and methods for providing navigational marks on a stringed instrument fingerboard. Navigational marks may be provided on a stringed instrument fingerboard to facilitate locating of musical notes. Thus, a player may learn to play the stringed instrument more efficiently and enhance his or her ability to improvise and read music.

According to various example embodiments, there is provided a method for providing navigational marks on a stringed instrument fingerboard. The method may include providing the fingerboard of the stringed instrument, one or more strings attached to the fingerboard, and navigational marks. The navigational marks may be disposed on the fingerboard in association with the strings to facilitate finding the note location. The navigational marks may include a plurality of types. Each type may be associated with a note of an octave and have a specific shape so that a player could locate notes based on the shape of the navigational marks.

In some embodiments, the type associated with a note C# may have the shape of an oval with a distinctive mark in an upper part of the oval; the type associated with a note D# may have the shape of the oval with the distinctive mark in a bottom part of the oval; the type associated with a note F# may have the shape of a sand glass with a distinctive mark in an upper part of the sand glass; the type associated with a note A# may have the shape of a sand glass with a distinctive mark in a bottom part of the sand glass; and the type associated with a note G# may have the shape of a sand glass with a distinctive mark in a middle part of the sand glass. Additionally, the shapes may be partial, for example, for the notes located on the outermost strings where the space to accommodate the navigational marks may be limited.

The navigational marks may have a sufficient size to be distinguished by the player. In various embodiments, a navigational mark length may constitute approximately 60-90% of a fret length.

Additionally, each type of navigational mark may be associated with a specific color. The player of the stringed instrument may thus differentiate the navigational marks not only by shape but also by color.

In various embodiments, the navigational marks may be attached to the fingerboard removably, comprise a component part of the fingerboard, or be paint marks on the fingerboard.

Additional systems, methods, apparatuses, features, and aspects are realized through the techniques of various embodiments of the disclosure. Other embodiments and aspects of the disclosure are described in detail below and are considered a part of the claimed disclosure. Other embodiments and aspects can be understood with reference to the description and the drawings.

### BRIEF DESCRIPTION OF THE DRAWINGS

Having thus described the disclosure in general terms, reference will now be made to the accompanying drawings, which are not necessarily drawn to scale, and wherein:

FIG. 1 shows an example notation of musical notes in association with piano keys.

FIG. 2 shows an example position of musical notes in association with strings of a guitar.

FIG. 3A shows a neck of a stringed instrument having a plurality of navigational marks disposed on a fingerboard, in accordance to some example embodiments.

FIG. 3B shows a neck of a stringed instrument having a plurality of navigational marks connected by connectors, in accordance to some example embodiments.

FIG. 4 shows an example set of navigational marks associated with musical notes, in accordance to some example embodiments.

FIG. 5 is an example flow diagram of a method for providing navigational marks on a fingerboard of a stringed instrument, according to one or more embodiments of the disclosure.

FIG. 6 is an example flow diagram of a method for designating navigational marks to a fingerboard of a stringed instrument, according to one or more embodiments of the disclosure.

### DETAILED DESCRIPTION

Illustrative embodiments of the disclosure now will be described more fully hereinafter with reference to the accompanying drawings, in which some but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout.

Overview

Systems and methods disclosed herein facilitate navigating a neck of a stringed instrument using navigational marks disposed on a stringed instrument fingerboard. The navigational marks may show where one or more musical notes are located on the fingerboard.

Since some stringed instruments provide their player a possibility to play the same note using different strings, learning musical note locations and reading music may present a challenge for the player. Though stringed instruments may have some marks (for example, frets and inlays), the player may still find it difficult to locate musical notes on the fingerboard.

The navigational marks disposed on the fingerboard may help the player locate musical notes. The navigational marks may include marks of several types, where each type may be associated with a musical note. Thus, a first type may be associated with note D#, a second type may be associated with note C#, and so forth. The types may be differentiated by shape and/or color so that the player can quickly orientate himself on the fingerboard.

Thus, the player of the stringed instrument may use the navigational marks as prompts for locating musical notes, reading music, and efficient improvisation.

The navigational marks may have sufficient size in order to be easily distinguished and discerned. However, since the navigational marks are associated with frets which differ in size, the size of the navigational marks may be related to the size of a fret.

Example Embodiments of the System

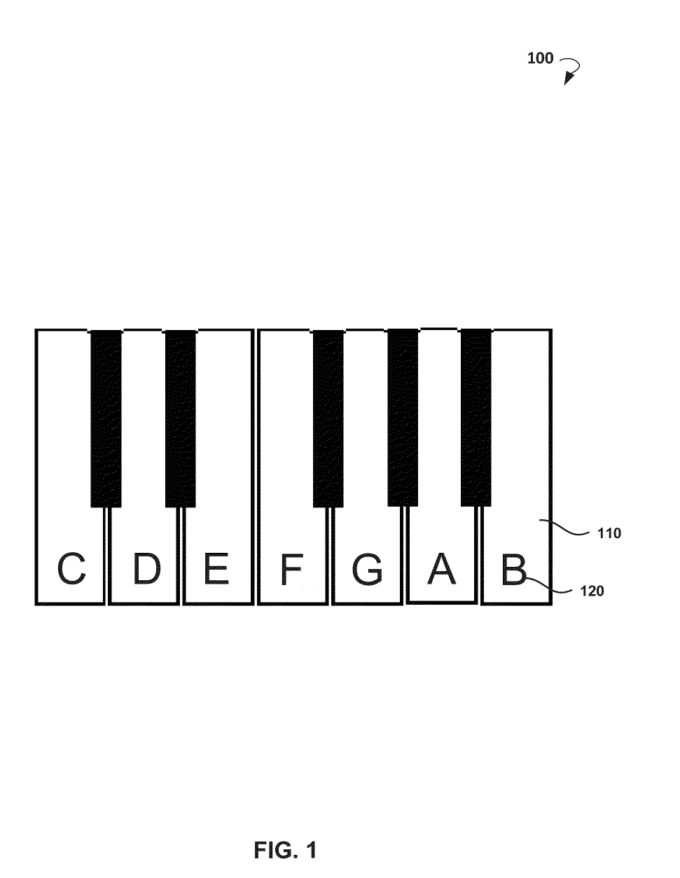

Referring now to the drawings, FIG. 1 shows an example notation 100 of musical notes 120 in association with piano keys 110. In a conventional notation, each piano key 110 is associated with a letter. Thus, notes 120 of an octave may be denoted as B, C, D, E, F, G, A.

The piano key 110 is usually associated with only one note 120. However, a stringed instrument allows a player to play different notes using the same string, or the same note on different strings.

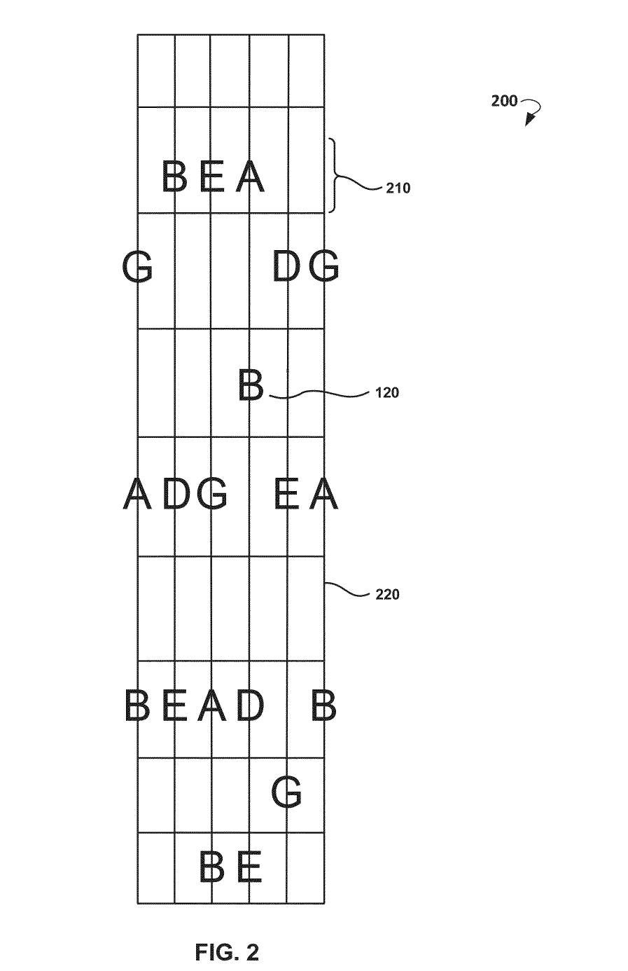

FIG. 2 illustrates an example position 200 of musical notes 120 in association with strings 220 of a guitar. The guitar may have a fingerboard (i.e., a strip of material on the front of the neck of a stringed instrument). Strings 220 may run above the fingerboard.

When playing such an instrument, a player presses (stops) the string 220 down to change its vibrating length. As a result, the pitch of the string 220 changes. By stopping the string 220 in different locations, the player may change a music note 120 generated by the string 220.

To facilitate locating musical notes 120 on a fingerboard of the guitar, various marks may be used. One example of such marks may be frets 210 (sections of the fingerboard divided by raised strips of hard material perpendicular to the strings).

For example, to play the note B, the player may stop string 5 on the second fret. Additionally, the same note may be played, for example, by stopping string 6 on the seventh fret, and so forth.

Although frets facilitate locating musical notes on the fingerboard, additional navigational marks showing locations of specific notes may be used.

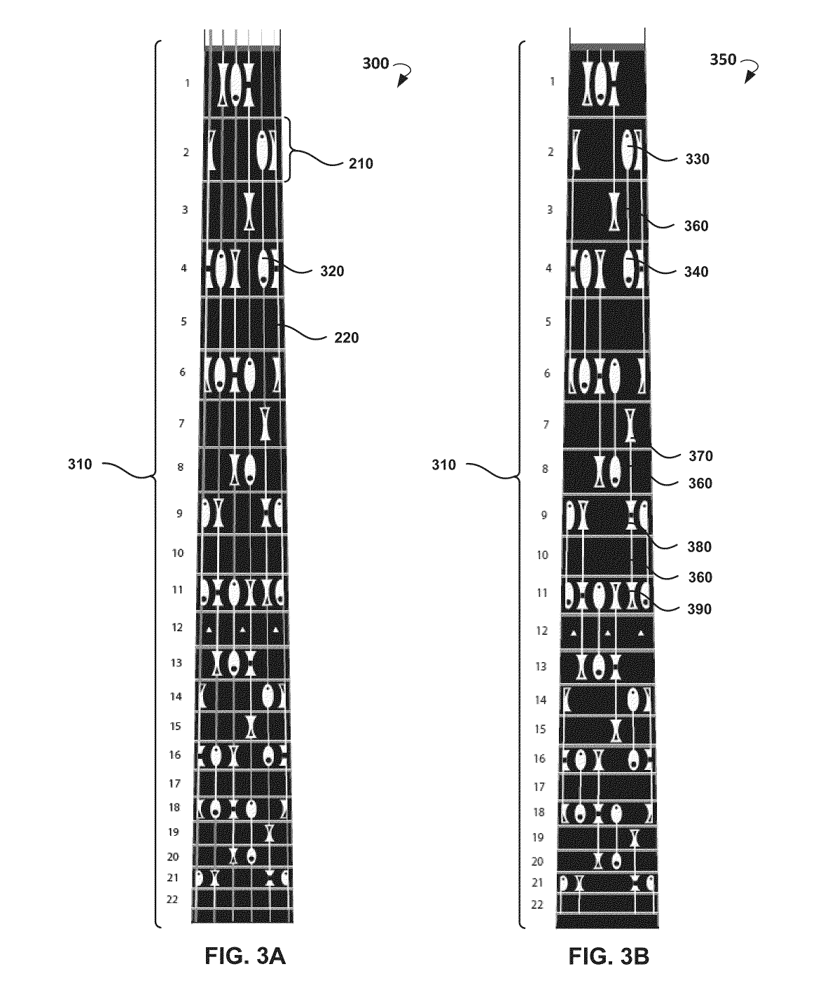

FIG. 3A shows a neck 300 of a stringed instrument having a plurality of navigational marks 320 disposed on a fingerboard 310, in accordance to some example embodiments. The stringed instrument may include an acoustic guitar, an electric guitar, a classical guitar, an electric bass guitar, a ukulele, and so forth.

The fingerboard 310 may include frets 210. Although FIG. 3 shows the fingerboard 310 having 22 frets 210, other numbers of frets 210 are also possible (for example, 19, 21, 24 frets, and so forth).

The navigational marks 320 may be used to mark locations associated with specific notes on the fingerboard 310. Each navigational mark 320 may be associated with a specific note location and be related to a specific string 220. Thus, the navigational mark 320 may be located under the string 220 in a location where the string 220 is stopped to produce a note.

The navigational marks 320 may include a plurality of types. Each type may be associated with a specific note of an octave. For example, a first type may be associated with note C, a second type may be associated with note D, and so forth. To differentiate between types, navigational marks of each type may have a specific shape. Thus, the player of the stringed instrument may locate musical notes on the fingerboard 310 at a glance by the shape of the navigational marks 320.

In other embodiments, the navigational marks may include additional types associated with other notes.

Geometrical shapes, with which the types are associated, may have sufficient size to be quickly and easily distinguished by a human eye. However, since the navigational marks 320 are associated with frets 210, the size of the navigational marks 320 may depend on the size of a fret 210 where they are located. For example, a navigational mark length may be 60% to 90% of the length of a fret associated with the navigational mark.

In some example embodiments, different types of the navigational marks 320 may be differentiated by different colors. In such a way, the player's ability to locate musical notes on the fingerboard 310 may be further enhanced.

The navigational marks 320, in various embodiments, may be removably attached to the fingerboard, comprise a component part of the fingerboard, be paint marks on the fingerboard, and so forth. For example, the navigational marks 320 may be stickers or adhesive labels removably attached to the fingerboard 310.

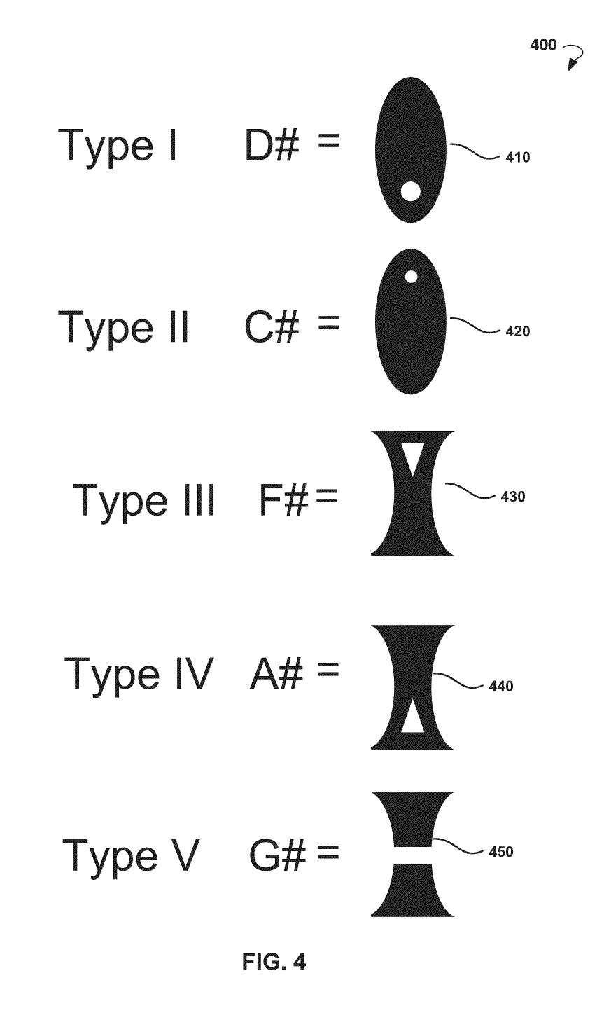

FIG. 3B shows a neck 350 of a stringed instrument having a plurality of navigational marks 320 connected by connectors 360, in accordance to some example embodiments. The navigational marks 320 disposed on a fingerboard 310 may include marks of two shape groups. One shape group of the navigational marks 320 may include oval shapes, for example, oval marks 330 and 340. Whereas the other shape group of the navigational marks 320 may include sand glass shapes, for example sand glass marks 370, 380, and 390. Every shape of the navigational marks 320 may be associated with a specific musical note. In more detail, various shapes of the navigational marks 320 are described below, with reference to FIG. 4.

The navigational marks 320 of the same group may be connected by a connector 360. The connector 360 may include a line-type graphic extending from one navigational mark 320 to another navigational mark 320 of the same shape group. For example, the connector 360 may connect the oval marks 330 and 340. Another connector 360 may connect sand glass marks 370, 380, and 390.

The connectors 360 may facilitate locating musical notes of the same shape group. Thus, players may locate notes on the fingerboard 310 more rapidly.

The connectors 360, in various embodiments, may be removably attached to the fingerboard, comprise a component part of the fingerboard, be paint marks on the fingerboard, and so forth. For example, the connectors 360 may be stickers or adhesive labels removably attached to the fingerboard 310.

FIG. 4 shows an example set 400 of navigational marks associated with musical notes, in accordance to some example embodiments.

According to an example embodiment, the navigational marks may include five types. Type I may be associated with note D#, type II—with note C#, type III—with note F#, IV—with note A#, and V—with note G#.

Every type may be represented by a specific distinctive shape. For example, Type I may have a shape 410 of an oval with a distinctive mark in a bottom part of the oval. The distinctive mark may include a circle or another mark.

Type II may have a shape 420 of the oval with the distinctive mark in an upper part of the oval. The distinctive mark may include a circle or another mark.

Type III may have a shape 430 of a sand glass with a distinctive mark in an upper part of the sand glass. The distinctive mark may include a triangle or another mark.

Type IV may have a shape 440 of a sand glass with a distinctive mark in a bottom part of the sand glass. The distinctive mark may include a triangle or another mark.

Type V may have a shape 450 of a sand glass with a distinctive mark in a middle part of the sand glass. The distinctive mark may include a horizontal line or another mark.

In some example embodiments, the navigational marks may include additional types associated with other musical notes.

In some example embodiments, types I-V may have different colors to provide additional differentiation characteristics. For example, Type I may have red color, Type II—blue, and so forth.

Additionally, according to some embodiments, the shapes of various types of the navigational marks may allow the player to notice them even when a neighboring string is stopped. Moreover, the oval and sand glass shapes may complement each other, allowing placement of the shapes next to each other on the fingerboard without overlapping of the shapes or reducing the size of the shapes.

The system for providing navigational marks on a fingerboard of a stringed instrument may be used to enhance player ability to navigate a stringed instrument neck and efficiently improvise and read music. The size and shape of the navigational marks may improve their distinctiveness and usage of space on the fingerboard.

Example Operation Method

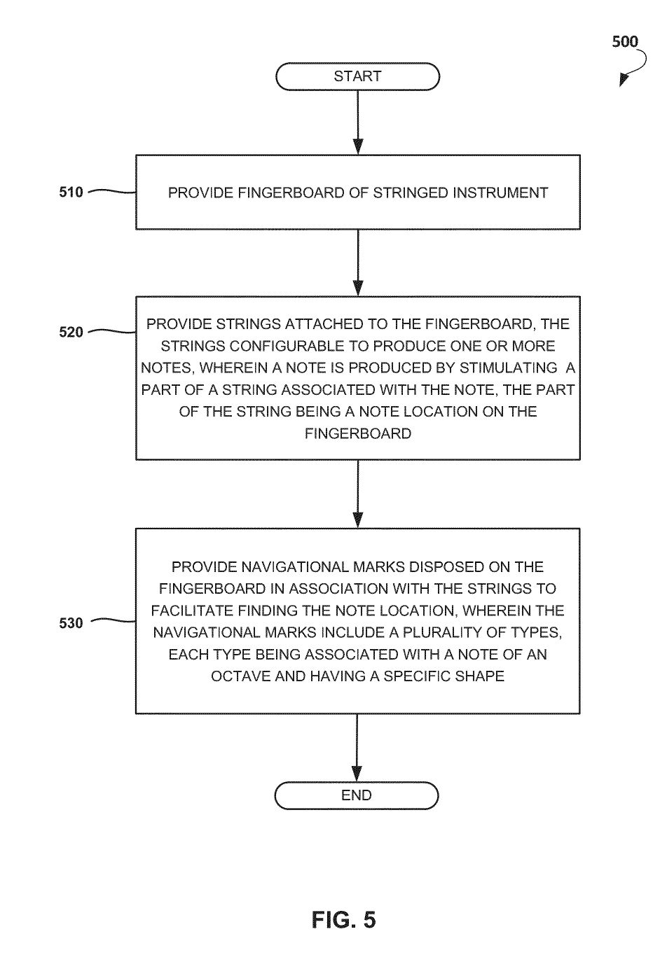

FIG. 5 is an example flow diagram of a method 500 for providing navigational marks on a fingerboard of a stringed instrument, according to one or more embodiments of the disclosure. The method 500 may be implemented by the system as described above with reference to FIGS. 3-4.

The method 500 may commence in operation 510 with providing the fingerboard of the stringed instrument. The stringed instrument may include an acoustic guitar, an electric guitar, a classical guitar, an electric bass guitar, a ukulele, and so forth. It should be mentioned that the terms “fingerboard” and “fretboard” are synonymous in the art and treated likewise in this application.

At operation 520, the method may continue with providing one or more strings attached to the instrument, over the fingerboard. The one or more strings may be configurable to produce one or more notes by stimulating a part of a string associated with the note. The part of the string may be referred to as a note location on the fingerboard.

At operation 530, the one or more navigational marks disposed on the fingerboard in association with the one or more strings may be provided. The one or more navigational marks may mark one or more note locations on the fingerboard, thus facilitating finding the note locations. The one or more navigational marks may include a plurality of types, each type being associated with a note of an octave and having a specific shape.

Additionally, the one or more navigational marks may be differentiated by color, with each color being associated with one of the plurality of types.

In various embodiments, the one or more navigational marks may be removably attached to the fingerboard, comprise a component part of the fingerboard, or may be paint marks on the fingerboard.

The one or more navigational marks may have sufficient size to be easily distinguished by a player. Thus, in some embodiments, a navigational mark length may constitute approximately 60-90% of a fret length.

In some embodiments, the type associated with a note C# may have a shape of an oval with a distinctive mark in an upper part of the oval. The type associated with a note D#—a shape of the oval with the distinctive mark in a bottom part of the oval. The type associated with a note F# may have a shape of a sand glass with a distinctive mark in an upper part of the sand glass. The type associated with a note A#—a shape of a sand glass with a distinctive mark in a bottom part of the sand glass. And the type associated with a note G# may have the shape of a sand glass with a distinctive mark in a middle part of the sand glass.

In some embodiments, some additional navigational marks may be used. For example, the additional navigational marks may be associated with other musical notes, such as C, F#, and so forth.

In some locations, for example associated with outermost strings, the shapes associated with the types of navigational marks may be partial. Thus, a navigational mark may be disposed in a limited space.

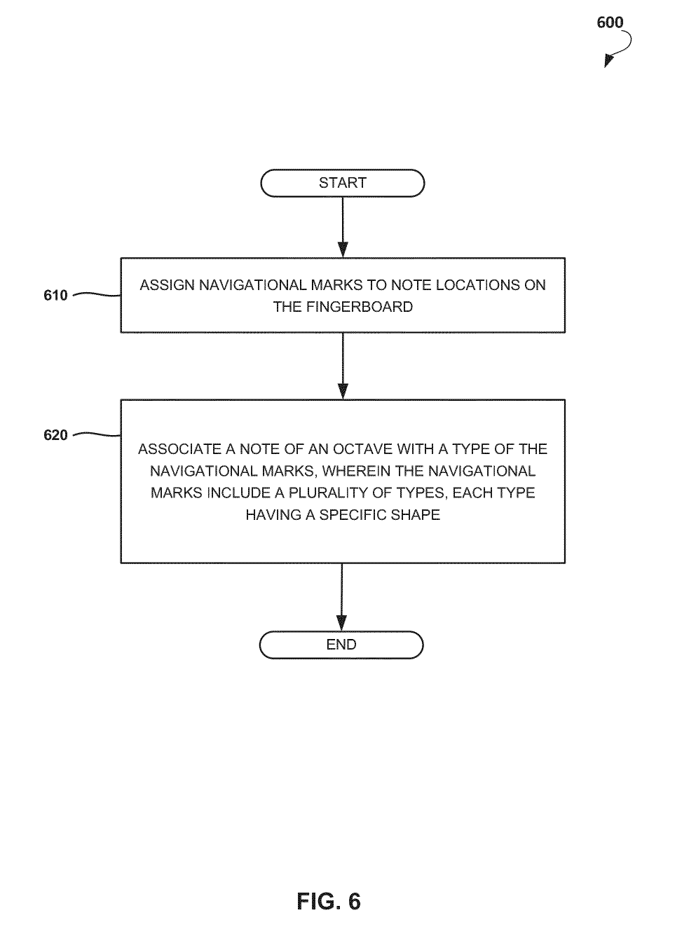

FIG. 6 is an example flow diagram of a method 600 for designating navigational marks to a fingerboard of a stringed instrument, according to one or more embodiments of the disclosure.

The method 600 may commence at operation 610 with assigning one or more navigational marks to one or more note locations on the fingerboard. The stringed instrument may include an acoustic guitar, an electric guitar, a classical guitar, an electric bass guitar, a ukulele, and so forth. The fingerboard may include a fretboard and may have frets. The note location may coincide with a place on the fingerboard where a string is stopped to produce the note.

At operation 620, a note of an octave may be associated with a type of the one or more navigational marks. The one or more navigational marks may include a plurality of types, each type having a specific shape. Thus, every type of the one or more navigational marks may be associated with a specific musical note.

Additionally, the one or more navigational marks may be differentiated by color. Each type of the navigational marks may be assigned a specific color to facilitate recognition of navigational marks on the fingerboard.

The shapes of the navigational marks may allow using navigational marks of sufficient size to be distinguished by the player. For example, a navigational mark length may constitute approximately 70% of a fret length. In other embodiments, the navigational mark length may constitute approximately 60% to 90% of the fret length.

Although the embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A system for providing one or more navigational marks on a fingerboard of a stringed instrument, the system comprising:
the fingerboard of the stringed instrument;
one or more strings associated with the fingerboard, the one or more strings configurable to produce one or more notes, wherein a note is produced by stimulating a part of a string associated with the note, the part of the string being a note location on the fingerboard; and
the one or more navigational marks disposed on the fingerboard in association with the one or more strings to facilitate finding the note location, the one or more navigational marks marking one or more note locations on the fingerboard, wherein the one or more navigational marks include a plurality of types, each type being associated with a note of an octave and having a specific shape.

2. The system of claim 1, wherein the one or more navigational marks are differentiated by color, each color being associated with one of the plurality of types.

3. The system of claim 1, wherein the stringed instrument includes an acoustic guitar, an electric guitar, a classical guitar, an electric bass guitar, or a ukulele.

4. The system of claim 1, wherein a navigational mark length constitutes approximately 60 to 90% of a fret length.

5. The system of claim 1, wherein the one or more navigational marks have sufficient size to be distinguished by a player.

6. The system of claim 1, wherein the one or more navigational marks are removably attached to the fingerboard, comprise a component part of the fingerboard, or are paint marks on the fingerboard.

7. The system of claim 1, wherein:
the type associated with a note C# has the shape of an oval with a distinctive mark in an upper part of the oval, or a part of the oval with the distinctive mark in the upper part of the oval;
the type associated with a note D# has the shape of the oval with the distinctive mark in a bottom part of the oval, or a part of the oval with the distinctive mark in the bottom part of the oval;
the type associated with a note F# has the shape of a sand glass with a distinctive mark in a upper part of the sand glass, or a part of the sand glass with the distinctive mark in the upper part of the sand glass;
the type associated with a note A# has the shape of a sand glass with a distinctive mark in a bottom part of the sand glass, or a part of the sand glass with the distinctive mark in the bottom part of the sand glass; and
the type associated with a note G# has the shape of a sand glass with a distinctive mark in a middle part of the sand glass, or a part of the sand glass with the distinctive mark in the middle part of the sand glass.

8. A method for providing one or more navigational marks on a fingerboard of a stringed instrument, the method comprising:
providing the fingerboard of the stringed instrument;
providing one or more strings attached to the stringed instrument over the fingerboard, the one or more strings configurable to produce one or more notes, wherein a note is produced by stimulating a part of a string associated with the note, the part of the string being a note location on the fingerboard; and
providing the one or more navigational marks disposed on the fingerboard in association with the one or more strings to facilitate finding the note location, the one or more navigational marks marking one or more note locations on the fingerboard, wherein the one or more navigational marks include a plurality of types, each type being associated with a note of an octave and having a specific shape.

9. The method of claim 8, wherein the one or more navigational marks are differentiated by color, each color being associated with one of the plurality of types.

10. The method of claim 8, wherein the stringed instrument includes an acoustic guitar, an electric guitar, a classical guitar, an electric bass guitar, or a ukulele.

11. The method of claim 8, wherein the one or more navigational marks have sufficient size to be distinguished by a player.

12. The method of claim 8, wherein a navigational mark length constitutes approximately 60 to 90% of a fret length.

13. The method of claim 8, wherein the one or more navigational marks are removably associated with and possibly attached to the fingerboard, comprise a component part of the fingerboard, or are paint marks on the fingerboard.

14. The method of claim 8, wherein:
the type associated with a note C# has the shape of an oval with a distinctive mark in an upper part of the oval, or a part of the oval with the distinctive mark in the upper part of the oval;
the type associated with a note D# has the shape of the oval with the distinctive mark in a bottom part of the oval, or a part of the oval with the distinctive mark in the bottom part of the oval;
the type associated with a note F# has the shape of a sand glass with a distinctive mark in a upper part of the sand glass, or a part of the sand glass with the distinctive mark in the upper part of the sand glass;
the type associated with a note A# has the shape of a sand glass with a distinctive mark in a bottom part of the sand glass, or a part of the sand glass with the distinctive mark in the bottom part of the sand glass; and
the type associated with a note G# has the shape of a sand glass with a distinctive mark in a middle part of the sand glass, or a part of the sand glass with the distinctive mark in the middle part of the sand glass.

15. A method for designating one or more navigational marks to a fingerboard of a stringed instrument, the method comprising:
assigning the one or more navigational marks to one or more note locations on the fingerboard; and
associating a note of an octave with a type of the one or more navigational marks, wherein the one or more navigational marks include a plurality of types, each type having a specific shape.

16. The method of claim 15, wherein the one or more navigational marks are differentiated by color, each color being associated with one of the plurality of types.

17. The method of claim 15, wherein the stringed instrument includes an acoustic guitar, an electric guitar, a classical guitar, an electric bass guitar, or a ukulele.

18. The method of claim 15, wherein a navigational mark length constitutes approximately 60 to 90% of a fret length.

19. The method of claim 15, wherein the one or more navigational marks have sufficient size to be distinguished by a player.

20. The method of claim 15, wherein the one or more navigational marks are removably associated with fingerboard, comprise a component part of the fingerboard, or are paint marks on the fingerboard.
